(19) United States
(12) Patent Application Publication
(10) Pub. No.: US 2026/0350630 A1
(43) Pub. Date: Nov. 5, 2026

(54) INFORMATION PROCESSING APPARATUS, INFORMATION PROCESSING METHOD, AND PROGRAM

(71) Applicant: NEC Corporation, Tokyo (JP)

(72) Inventors: So YAMADA, Tokyo (JP); Megumi ETO, Tokyo (JP); Rika KONNO, Tokyo (JP)

(73) Assignee: NEC Corporation, Tokyo (JP)

(21) Appl. No.: 19/488,107

(22) PCT Filed: Jun. 27, 2023
(86) PCT No.: PCT/JP2023/023815

§ 371 Date: Nov. 26, 2025

(51) Int. Cl. G06Q 30/018

(52) U.S. Cl. CPC G06Q 30/018

(57) ABSTRACT

An information processing apparatus 100 of the present disclosure includes a storing unit 121 that stores a relational expression using the quantity of events by event type and the emission amount of a predetermined substance set according to the event type, and a calculation unit 122 that calculates the quantity of the events by the event type on the basis of the relational expression. Accordingly, the information apparatus supports environmental-conscious decision making by employing artificial intelligence-based optimization.

### TECHNICAL FIELD

The present disclosure relates to an information processing apparatus, an information processing method, and a program.

### BACKGROUND ART

In recent years, there is a demand to reduce emissions of substances that are environmental load factors, such as greenhouse gases like carbon dioxide and air pollutants like nitrogen oxides. In this regard, Patent Literature 1 describes calculating the amount of emissions of environmental load factors caused by owned items such as equipment possessed by a business operator.

### CITATION LIST

### Patent Literature

Patent Literature 1: JP 7043691 B

### SUMMARY OF INVENTION

### Technical Problem

In the case of a business operator, introduction or replacement of physical objects such as equipment may occur depending on the business situation, causing fluctuations in the owned objects. However, with the technology described in Patent Literature 1, it is difficult to recognize the amount of emissions of environmental load factors due to fluctuations in the owned objects. This causes a problem that it is difficult to plan introduction of objects while considering the environment. Also, it is difficult not only to introduce objects by a business operator but also to plan events that may be performed by a business operator.

Therefore, an object of the present disclosure is to solve the aforementioned problem, that is, a problem that it is difficult to plan events while considering the environment.

### Solution to Problem

An information processing apparatus, according to one aspect of the present disclosure, is configured to include
a storing unit that stores a relational expression using the quantity of events by event type and the emission amount of a predetermined substance set according to the event type, and
a calculation unit that calculates the quantity of the events by the event type on the basis of the relational expression.

Further, an information processing method, according to one aspect of the present disclosure, is configured to include,
on a basis of a relational expression using the quantity of events by event type and the emission amount of a predetermined substance set according to the event type, calculating the quantity of the events by the event type.

Further, a program according to one aspect of the present disclosure is configured to,
on a basis of a relational expression using the quantity of events by event type and the emission amount of a predetermined substance set according to the event type, calculate the quantity of the events by the event type.

### Advantageous Effects of Invention

With the configurations as described above, the present disclosure is able to support planning of events while considering the environment.

### BRIEF DESCRIPTION OF DRAWINGS

FIG. 1 is a block diagram illustrating a configuration of a first information processing apparatus according to the present disclosure.

FIG. 2 is a diagram illustrating a state of processing by the first information processing apparatus according to the present disclosure.

FIG. 3 is a flowchart illustrating a processing operation of the first information processing apparatus according to the present disclosure.

FIG. 4 is a block diagram illustrating a hardware configuration of a second information processing apparatus according to the present disclosure.

FIG. 5 is a block diagram illustrating a configuration of the second information processing apparatus according to the present disclosure.

### DESCRIPTION OF EXAMPLE EMBODIMENTS

### First Example Embodiment

A first example embodiment of the present disclosure will be described with reference to the drawings. In the present disclosure, the drawings may be associated with any example embodiments.

### Configuration

An information processing apparatus 10 in this example embodiment is used to support planning of events that can be taken by a business operator, such as introducing objects or implementing measures, in order to contribute to reduction of the environmental load of the business operator. In this example embodiment, a case of a business operator who operates delivery services or visit services using vehicles will be described as an example. In this case, the business operator owns a plurality of vehicles to conduct the business, but it may become necessary to replace a plurality of vehicles depending on the business situation and elapse of time. Therefore, the business operator will plan introduction of vehicles while considering the environment; this example embodiment exemplifies the case where the information processing apparatus 10 supports planning of introduction of vehicles (objects). In this example embodiment, owning vehicles of each type according to a pre-set classification is handled as an event, and the number of vehicles by type is set as the quantity of events. However, the quantity of events is not limited to representing the number of owned objects such as vehicles by type, but may also be the number of times or amount of actions or measures that a business operator may take.

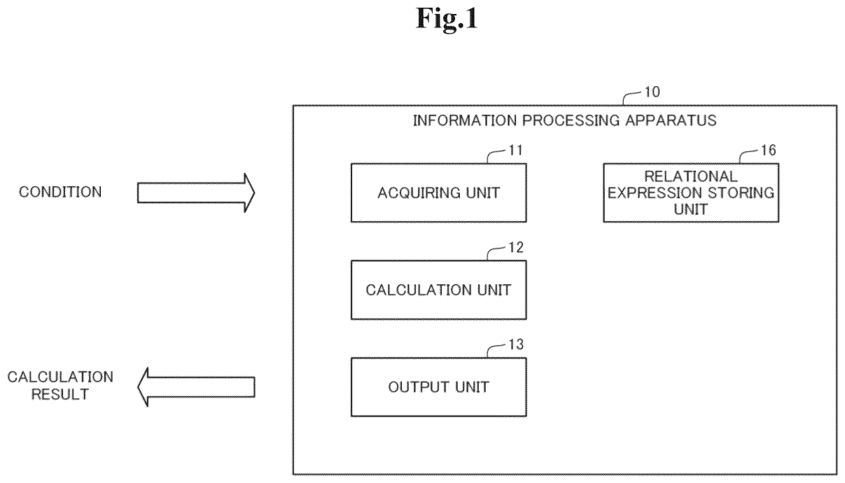

The information processing apparatus 10 is configured of one or a plurality of information processing apparatuses each including an arithmetic logic unit and a memory unit. As illustrated in FIG. 1, the information processing apparatus 10 includes an acquiring unit 11, a calculation unit 12, and an output unit 13. The functions of the acquiring unit 11, the calculation unit 12, and the output unit 13 can be realized by executing a program stored in the storage device. The information processing apparatus 10 also includes a relational expression storing unit 16. The relational expression storing unit 16 is configured of a storage device. The respective components will be described in detail below.

The relational expression storing unit 16 stores relational expressions related to the number of vehicles by type, which are used to support formulation of a vehicle introduction plan by the business operator. In this example embodiment, two relational expressions, namely a first relational expression and a second relational expression, are stored. The first relational expression represents the relationship between the number of vehicles (objects) by type and the emission amount of carbon dioxide (specified substance) emitted from the vehicles. The second relational expression represents the relationship between the number of vehicles (objects) by type and the cost (evaluation value) of the energy used by the vehicles.

Specifically, the first relational expression is expressed in a linear form as shown in Expression 1 below.

yₜ=a₁ₜx₁ₜ+a₂ₜx₂ₜ+ . . . +aₙₜxₙₜ [Expression 1]

Here, a response variable yt represents the emission amount of carbon dioxide (CO₂) in each period t. An explanatory variable xᵢₜ represents the number of vehicles by type i in each period t. A coefficient aᵢₜ represents the emission amount of carbon dioxide emitted per vehicle by each type i in each period t. However, the coefficient aᵢₜ may lack dependency on the period t, and may be represented simply as a coefficient aᵢ. Moreover, y itself may not have a subscript t, and in this case, both the explanatory variable xᵢₜ and the coefficient aᵢₜ lack the subscript t, and y becomes the total emission amount of carbon dioxide.

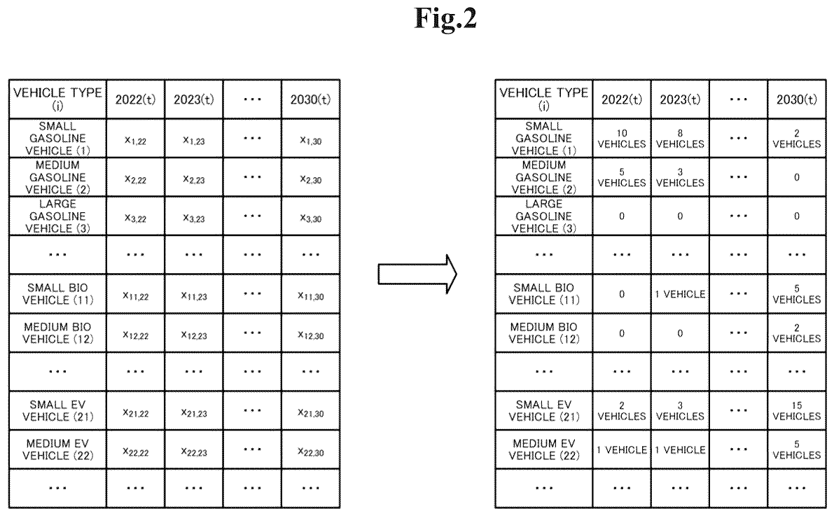

Here, a plurality of vehicle types i are set in advance. In this example embodiment, the vehicle type i is classified according to the usage status of the energy utilized by the power source (power unit) of the vehicle such as an engine or a motor. Furthermore, the usage status of the energy is also classified according to the type of energy and the size of the vehicle (power source). As an example, the types of energy include gasoline, biofuel, and electricity. The types of vehicles on the basis thereof include gasoline/diesel vehicles (hereinafter referred to as gasoline vehicles), biofuel vehicles (hereinafter referred to as BIO vehicles), and electric vehicles (hereinafter referred to as EV vehicles). Moreover, vehicle sizes include small, medium, large, tractor vehicles, and the like. For this reason, the vehicle type i is determined by the combination of the type of energy and the size of the vehicle as illustrated in FIG. 2, such as a small gasoline vehicle (1), a medium gasoline vehicle (2), a large gasoline vehicle (3), . . . , a small BIO vehicle (11), a medium BIO vehicle (12), . . . , a small EV vehicle (21), a medium EV vehicle (22), and the like. However, the vehicle types are not limited to the examples listed above, and may be set according to any classification.

The period t is set to one year in this example embodiment, and as illustrated in FIG. 2, each year from 2022 to 2030 is set. As a result, as illustrated in the left figure of FIG. 2, the number of vehicles xᵢₜ by type is shown differently for each type i and for each period t. The period is not limited to one year and may be any period. The period may not be set, and in this case, the number of vehicles is represented by xᵢ.

A coefficient “a” represents the emission amount of carbon dioxide emitted in one year per vehicle, and is predetermined depending on the type i of the vehicle. For example, in the case of gasoline vehicles (gasoline/diesel vehicles), the coefficient “a” is a value calculated by “(fuel consumption amount [kl/vehicle per year])×(carbon dioxide emission coefficient [t−CO₂/kl])”. Here, the fuel consumption amount is calculated from the travel distance and the fuel efficiency for each vehicle type i in a predetermined business operator, for example. Therefore, the fuel consumption amount varies depending on the size of the vehicle. In the case of a BIO vehicle, the coefficient “a” is a value calculated by “(fuel consumption amount [kl/vehicle per year])×(carbon dioxide emission coefficient [t−CO₂/kl])×0.8”. The reason why the fuel consumption amount and the carbon dioxide emission coefficient are multiplied by 0.8 is that the BIO vehicle's fuel contains 20% biofuel mixed with diesel, so that the amount of carbon dioxide emissions is reduced. However, the coefficient “a” for BIO vehicles may be appropriately set according to the blending ratio of biofuel. In the case of EV vehicles, the coefficient “a” is a value calculated by “(power consumption amount [kwh/vehicle per year])×(carbon dioxide emission coefficient [t−CO₂/kwh])”. At this time, the power consumption amount is calculated from, for example, a monthly travel distance and the power efficiency for each vehicle type i in a predetermined business operator. Furthermore, the coefficient “a” in which the time dependency t is taken into account can express cases such as the fuel consumption amount gradually increasing or decreasing, or the method of calculating the carbon dioxide emission coefficient gradually increasing or decreasing.

The second relational expression is represented in a linear form as shown in the following Expression 2.

y′ₜ=b₁ₜx₁ₜ+b₂ₜx₂ₜ+ . . . +bₙₜxₙₜ [Expression 2]

Here, a response variable y′ₜ represents the price (cost) of the energy (fuel, electricity) for each period t. The explanatory variable xᵢₜ represents the number of vehicles by the type i in each period t. A coefficient “bᵢₜ” represents the price (cost) of the energy (fuel, electricity) per vehicle by the type i in each period t. Note that y′ may not have the subscript t, and in this case, y′ denotes the total price.

Here, a coefficient “b” represents the price of energy per vehicle for one year, and it is set in advance according to the vehicle type i. For example, in the case of gasoline vehicles (gasoline/diesel vehicles), the coefficient “b” represents a value calculated by “(fuel consumption amount [kl/vehicle per year])×(fuel price [yen (t)/kl])”. At this time, the fuel price in which the time dependence t is taken into account is obtained from an external database and is used either directly as the current value and a forecast for each year, or by calculating intermediate values through linear interpolation between the current value and a forecast for a certain year. The coefficient “b” in BIO vehicles and EV vehicles is also set based on the price of BIO fuel and the electricity price, similarly to the above.

The aforementioned first relational expression and second relational expression are assumed to be created in advance, input into the information processing apparatus 10, and stored in the relational expression storing unit 16. At this time, the aforementioned coefficients “a” and “b” may be appropriately modified and reflected in each relational expression.

The acquiring unit 11 acquires the first relational expression, the second relational expression, and the conditions on the variables contained in these expressions, input from the business operator. The conditions are those to be satisfied by the variables included in the first relational expression and the second relational expression when the number of vehicles by type is calculated using the first relational expression and the second relational expression by the calculation unit 12, as described later. For example, the conditions are represented as those to be satisfied with respect to the emission amount y, the number of vehicles x by type, and the cost y′.

As an example, the conditions are represented as follows:
Minimize the total price (cost) y′ over a year t

### Decrease the Second Relational Expression

The carbon dioxide emission amount yₜ for each year t is set to be equal to or less than a target value for each year t

### Make the First Relational Expression Equal to or Smaller than a Target Value

The total number of vehicles x for each year t is set to be equal to or less than a set value

### Ensure the Number of Vehicles so as not to Affect the Business

The total number of vehicles x of a specific type (gasoline vehicles) for each year t is set to be equal to or less than a set value

### Decrease the Number of Gasoline Vehicles x as Each Year t Passes

The total number of vehicles x of specific types (BIO vehicles, EV vehicles) for each year t is set to be equal to or greater than a set value

### Increase the Number of BIO Vehicles and EV Vehicles x as Each Year t Passes

An increase in the number of specific types of vehicles (BIO vehicles, EV vehicles) each year t is set to be equal to or less than a set value

### Prevent a Rapid Increase in BIO Vehicles and EV Vehicles

However, the conditions are not limited to the contents described above and may be any contents.

The calculation unit 12 calculates the number of vehicles by type so as to satisfy the conditions including the first relational expression, the second relational expression, and the like. At this time, the calculation unit 12 calculates the number of vehicles by type as a solution to satisfy the conditions including the first relational expression, the second relational expression, and the like, using a mathematical optimization method (for example, mixed integer linear programming). For example, the calculation unit 12 obtains the number of vehicles by type per year by setting the carbon dioxide emission amount yₜ per year to be equal to or less than a target value in the first relational expression, minimizing the total cost y′ per year in the second relational expression, and further, satisfying the conditions set for the vehicle number x.

The output unit 13 outputs the number of vehicles by type per year calculated by the calculation unit 12 so that the business operator can recognize it. For example, as illustrated in the right figure of FIG. 2, the number of vehicles by type is displayed for each year.

### Operation

Next, operation of the information processing apparatus 10 will be described.

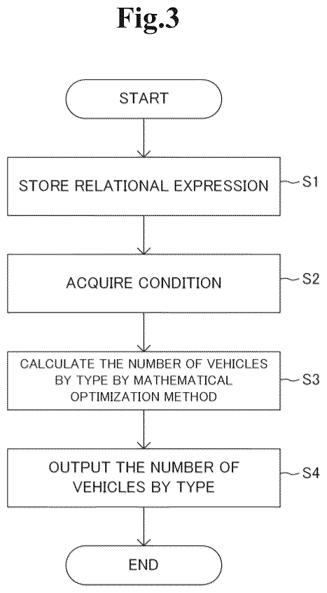

First, it is assumed that the first relational expression and the second relational expression have been input and stored in the information processing apparatus 10 (step S1 in FIG. 3). In such a situation, the business operator inputs conditions set according to the environmental goal and the business goal into the information processing apparatus 10. The conditions include making the amount of carbon dioxide emissions equal to or less than a target value, minimizing the costs, the number of specific types of vehicles, and the like. As a result, the information processing apparatus 10 acquires the conditions (step S2 of FIG. 3).

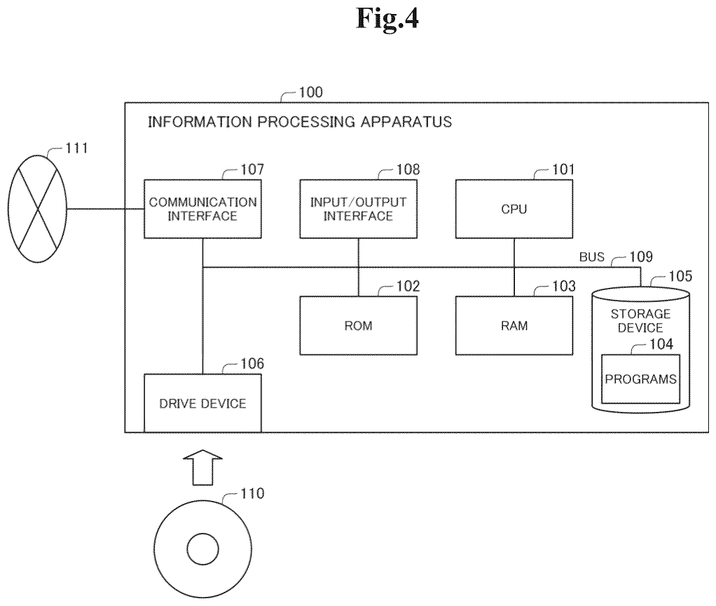

Then, the information processing apparatus 10 uses a mathematical optimization method (for example, mixed-integer linear programming) so as to satisfy the conditions including the first relational expression and the second relational expression, to thereby calculate the number of vehicles by type per year (step S3 of FIG. 3). Then, the information processing apparatus 10 outputs the calculated number of vehicles by type per year to the business operator (step S4 in FIG. 4).

As described above, according to this example embodiment, since the number of vehicles by type is calculated using the relational expressions between the number of vehicles by type and the amount of carbon dioxide emissions, the business operator can easily make a vehicle introduction plan in consideration of the environment. In particular, by setting the amount of carbon dioxide emissions to be a target value or less, minimizing the costs, and further setting the number of vehicles as conditions, it is possible to support formulation of a vehicle introduction plan that enables the environmental goal and the business goal to be achieved.

Note that the above example has illustrated the case of calculating the number of vehicles by type for each period t such as one year, but the period does not necessarily have to be set. In this case, simply, the number of vehicles by type without specifying a period will be calculated.

Moreover, in the above description, the first relational expression and the second relational expression are exemplified as being represented in linear form as shown in Expression 1 and Expression 2, but the first relational expression and the second relational expression may also be expressed in non-linear form. In this case, the calculation unit 12 may calculate the number of vehicles by type as a solution by means of a method such as exhaustive search, second-order cone optimization, semidefinite optimization, polynomial optimization, or the like, in order to satisfy the conditions.

### Modification 1

Next, a modification of the processing performed by the information processing apparatus 10 will be explained. Here, a modification of the first relational expression will be explained.

In the above description, the response variable y in the first relational expression shown as Expression 1 is the emission amount of carbon dioxide emitted from the vehicle, but the response variable y may be the emission amount of a predetermined substance that serves as an environmental load factor, such as greenhouse gases including other substances or atmospheric pollutants like nitrogen oxides, without being limited to carbon dioxide. In this case, the coefficient “a” represents the emission amount of a predetermined substance per vehicle by type, and as a condition, a condition that the emission amount of a predetermined substance is equal to or less than a target value may be set.

### Modification 2

Next, a modification of the processing performed by the information processing apparatus 10 will be explained. Here, a modification of the second relational expression will be explained.

In the above description, the response variable y′ in the second relational expression shown as Expression 2 is the price of energy (fuel, electricity), but such an response variable y′ is a value different from the amount of emissions set in the first relational expression and may be another value (evaluation value) set according to the vehicle. For example, the response variable y′ in the second relational expression may be the price of a vehicle itself. In this case, the coefficient “b” may be the purchase price per vehicle by type or the lease price per year, for example. As a condition, a condition that the total y′ of the price of the vehicle itself per year is minimized may be set.

Further, for example, the response variable y′ in the second relational expression may be the sales or profit of the business by the business operator. In this case, the coefficient “b” may be the sales or profit per vehicle by type, or the like. As a condition, a condition that the sales or profit y′ is maximized may be set.

Further, for example, the response variable y′ in the second relational expression may represent the time or work hours required when a business operator conducts business. In this case, the coefficient “b” may represent the time or work hours required per vehicle by type. As a condition, a condition that the time or work hours are minimized may be set.

Further, for example, the response variable y′ in the second relational expression may be an ESG (E: Environment, S: Social, G: Governance) score that is an indicator used to evaluate efforts towards ESG by a business operator (company). In this case, the coefficient “b” may be an ESG score that can be calculated per vehicle by type. As a condition, a condition that the ESG score is maximized may be set. Instead of the above ESG score, another evaluation value may be used as the response variable y′.

### Modification 3

Next, another modification of the processing performed by the information processing apparatus 10 will be explained. In this example embodiment, the case where the information processing apparatus 10 is applied to a business content different from that of the first example embodiment will be explained. In the above description, the explanatory variable x in the first relational expression and the second relational expression is the number of vehicles by type, but the explanatory variable x may be another equipment or material.

As an example, when a business operator engages in the business of constructing or designing buildings, the explanatory variable x may be the quantity by type of materials used in the building (such as wall materials, flooring materials) or equipment installed (such as solar panels, water heaters, electrical appliances). In this case, the response variable y in the first relational expression represents the amount of carbon dioxide emissions as mentioned above, and the coefficient “a” represents the amount of carbon dioxide emissions per unit quantity during manufacturing and use of materials or equipment. Additionally, the response variable y′ in the second relational expression may represent the introduction cost or running cost of materials or equipment, energy consumption associated with the use of materials or equipment, time required for construction, a specified environmental evaluation value, or the like, and the coefficient “b” represents a value corresponds to the response variable y′ per unit quantity during manufacturing and use of materials or equipment. As conditions, it is possible to set making the amount of carbon dioxide emissions that is the response variable y in the first relational expression equal to or less than a certain value, minimizing the cost that is the response variable y′ in the second relational expression, the necessary quantities of various materials and equipment that are explanatory variable x, and the like. As a result, the information processing apparatus 10 can calculate the quantities of materials and equipment required for a building that can be constructed at low cost and within a short construction period while considering the environment.

Further, as an example, in the case where a business operator provides food and beverages, the explanatory variable x may be the quantity by type of ingredients (beef, chicken, vegetables, and the like) used for the food and beverages or tableware (plates, chopsticks, and the like). In this case, the response variable y in the first relational expression represents the amount of carbon dioxide emissions as described above, and the coefficient “a” represents the amount of carbon dioxide emissions per unit quantity during manufacturing and use of ingredients and tableware. For example, for ingredients, it is set based on the amount of carbon dioxide emissions discharged during rearing or cultivation of the ingredients, and for tableware, when it is made of wood, it is set based on the amount of carbon dioxide emissions that may increase due to logging of trees. Moreover, the response variable y′ in the second relational expression may represent costs of ingredients or tableware or the like, and the coefficient “b” represents a value corresponding to the response variable y′ per unit quantity during manufacturing and use of ingredients and tableware. As conditions, making the amount of carbon dioxide emissions represented by the response variable y in the first relational expression equal to or less than a certain value, minimizing the cost represented by the response variable y′ in the second relational expression, the required quantities of ingredients and tableware, and the like can be set. As a result, the information processing apparatus 10 can calculate the quantities of ingredients and tableware required for the food and beverages provided at low cost while considering the environment.

Further, as an example, when a business operator uses it for planning transportation means for employees, the explanatory variable x may be presence/absence of use and the travel distance for each type of transportation such as train, bus, car, bicycle, and walking. In this case, the response variable y in the first relational expression represents the amount of carbon dioxide emissions as described above, and the coefficient “a” represents the amount of carbon dioxide emissions per unit distance when the transportation means is used. Further, the response variable y′ in the second relational expression may represent the cost or travel time when the transportation means is used, and the coefficient “b” represents the value corresponding to the response variable y′ per unit distance when the transportation means is used. As conditions, making the amount of carbon dioxide emissions that is the response variable y in the first relational expression equal to or less than a certain value, minimizing the cost or travel time that is the response variable y′ in the second relational expression, and the like can be set. As a result, the information processing apparatus 10 is able to calculate a transportation means that enables traveling at low cost and in a short time while considering the environment.

### Modification 4

Next, another modification of the processing performed by the information processing apparatus 10 will be explained. In the information processing apparatus 10 described above, the case of calculating the number of vehicles by type using the first relational expression and the second relational expression has been given as an example. However, the information processing apparatus 10 may calculate the number of vehicles by type so as to satisfy the conditions using only the first relational expression. In this case, as conditions, making the amount of carbon dioxide emissions that is the response variable y in the first relational expression equal to or less than a certain value, constraints on the number of vehicles by type, and the like may be set. The information processing apparatus 10 may calculate the number of vehicles by type based solely on the first relational expression so as to satisfy the conditions. As a result, the information processing apparatus 10 is able to calculate the number of vehicles by type while considering the environment. Even in the case of using only the first relational expression as described above, the response variable y, the explanatory variable x, and the coefficient “a” can be appropriately set according to the various businesses mentioned above.

### Second Example Embodiment

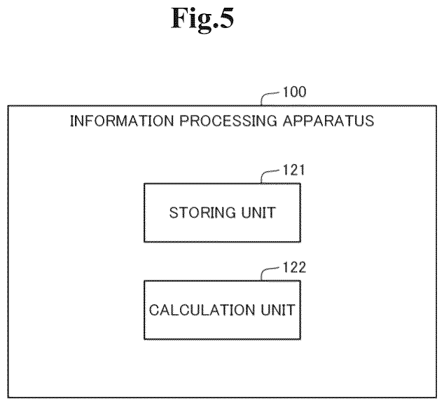

Next, a second example embodiment of the present disclosure will be described with reference to the drawings. In this example embodiment, an outline of the configuration of the information processing apparatus described in the above embodiment is shown. FIGS. 4 and 5 are diagrams for explaining the configuration, and these drawings may be related to any of the embodiments.

First, with reference to FIG. 4, the hardware configuration of an information processing apparatus 100 will be described. The information processing apparatus 100 is configured as a general information processing apparatus and, as an example, is equipped with the following hardware configuration.
a CPU (Central Processing Unit) 101 (arithmetic logic unit);
a ROM (Read Only Memory) 102 (memory unit);
a RAM (Random Access Memory) 103 (memory unit);
programs 104 loaded into RAM 103;
a storage device 105 storing the programs 104;
a drive device 106 that performs reading from and writing into a storage medium 110 external to the information processing apparatus;
a communication interface 107 that connects to a communication network 111 external to the information processing apparatus;
an input/output interface 108 that performs input and output of data; and
a bus 109 connecting the components.

FIG. 4 illustrates an example of the hardware configuration of an information processing apparatus that is the information processing apparatus 100, and the hardware configuration of the information processing apparatus is not limited to the abovementioned case. For example, the information processing apparatus may be configured of a part of the aforementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The information processing apparatus 100 is able to construct and include a storing unit 121 and a calculation unit 122 illustrated in FIG. 5 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or they may be stored in advance in the storing unit 110, and the drive device 106 may read out the programs and provide them to the CPU 101. However, the aforementioned storing unit 121 and calculation unit 122 may be constructed of dedicated electronic circuits to realize such means.

The storing unit 121 stores therein relational expressions using the quantity for each type of predetermined event and the emission amount of a predefined substance set according to each event type. The calculation unit 122 calculates the quantity of events by type based on the relational expressions. At this time, the calculation unit 122 may calculate the quantity of events by type based on the relational expressions so as to satisfy the conditions set for the variables included in the relational expressions.

As configured as described above, the present disclosure enables calculation of the quantity of events by type based on relational expressions using the quantity of events by type and the emission amount of a predetermined substance set for each event type. Therefore, it is possible to calculate the quantity of events by type while considering the environment, thereby supporting the planning of events.

Note that at least one of the functions of the storing unit 121 and the calculation unit 122 described above may be executed on an information processing apparatus installed and connected anywhere on the network; that is, it may be executed in so-called cloud computing.

The aforementioned programs can be stored using various types of non-transitory computer-readable media and provided to a computer. The non-transitory computer-readable media include various types of tangible storage media. Examples of non-transitory computer-readable media include magnetic recording media (e.g., flexible disk, magnetic tape, hard disk drive), magneto-optical recording media (e.g., magneto-optical disk), read only memories (CD-ROM), CD-R, CD-R/W, and semiconductor memories (e.g., mask ROM, programmable ROM (PROM), erasable PROM (EPROM), flash ROM, and random access memory (RAM)). In addition, a program may be provided to a computer by various types of transitory computer-readable media. Examples of transitory computer-readable media include electrical signals, optical signals, and electromagnetic waves. A transitory computer-readable medium may provide a program to the computer via a wired communication channel, such as an electric wire and an optical fiber, or a wireless communication channel.

Although the present disclosure has been described above with reference to the above-described example embodiments, the present disclosure is not limited to the example embodiments described above. The configuration and details of the present disclosure can be changed in a variety of ways that those skilled in the art can understand within the scope of the present disclosure. The above-mentioned example embodiments can be appropriately combined with other embodiments.

### Supplementary Note

The whole or part of the example embodiments disclosed above can be described as the following supplementary notes. Below is the overview of the configurations of an information processing apparatus, an information processing method, and a program in the present disclosure. However, the present disclosure is not limited to the following configurations.

### Supplementary Note 1

An information processing apparatus comprising:
a storing unit that stores a relational expression using a quantity of events by event type and an emission amount of a predetermined substance set according to the event type; and
a calculation unit that calculates the quantity of the events by the event type on a basis of the relational expression

### Supplementary Note 2

The information processing apparatus according to supplementary note 1, wherein
the calculation unit calculates the quantity of the events by the event type on a basis of the relational expression so as to satisfy a condition set for a variable included in the relational expression.

### Supplementary Note 3

The information processing apparatus according to supplementary note 2, wherein
the calculation unit calculates the quantity of the events by the event type on the basis of the relational expression so as to satisfy the condition set for the emission amount included in the relational expression.

### Supplementary Note 4

The information processing apparatus according to supplementary note 2, wherein
the calculation unit calculates the quantity of the events by the event type on the basis of the relational expression so as to satisfy the condition set for the quantity of the events by the event type included in the relational expression.

### Supplementary Note 5

The information processing apparatus according to supplementary note 1, wherein
the storing unit stores a second relational expression using the quantity of the events by the event type and an evaluation value that is set according to the event type and is different from the emission amount, and
the calculation unit calculates the quantity of the events by the event type based on the relational expression and the second relational expression.

### Supplementary Note 6

The information processing apparatus according to supplementary note 5, wherein
the calculation unit calculates the quantity of the events by the event type on the basis of the relational expression and the second relational expression so as to satisfy a second condition set for a variable included in the second relational expression.

### Supplementary Note 7

The information processing apparatus according to supplementary note 6, wherein
the calculation unit calculates the quantity of the events by the event type on the basis of the relational expression and the second relational expression so as to satisfy the second condition set for the evaluation value included in the second relational expression.

### Supplementary Note 8

The information processing apparatus according to supplementary note 6, wherein
the calculation unit calculates the quantity of the events by the event type on the basis of the relational expression and the second relational expression so as to satisfy the second condition set for the quantity of the events by the event type included in the second relational expression.

### Supplementary Note 9

The information processing apparatus according to supplementary note 1, wherein
the storing unit stores the relational expression using the quantity of the events by the event type and the emission amount for each period set in advance, and
the calculation unit calculates the quantity of the events by the event type for the each period on a basis of the relational expression.

### Supplementary Note 10

The information processing apparatus according to supplementary note 5, wherein
the storing unit stores the relational expression using the quantity of the events by the event type and the emission amount for each period set in advance, and stores the second relational expression using the quantity of the events by the event type and the evaluation value for the each period, and
the calculation unit calculates the quantity of the events by the event type for the each period on the basis of the relational expression and the second relational expression.

### Supplementary Note 11

The information processing apparatus according to supplementary note 1, wherein
the storing unit stores the relational expression using the quantity of the events by the event type set according to an energy usage status by the event, and the emission amount set according to the event type.

### Supplementary Note 12

The information processing apparatus according to supplementary note 11, wherein
the storing unit stores the relational expression using a number of owned vehicles by vehicle type, the vehicles being the events, and the emission amount set according to the vehicle type.

### Supplementary Note 13

The information processing apparatus according to supplementary note 5, wherein
the storing unit stores the relational expression using the quantity of the events by the event type set according to an energy usage status by the event and the emission amount set according to the event type, and also stores the second relational expression using the quantity of the events by the event type and the evaluation value set according to the event type.

### Supplementary Note 14

The information processing apparatus according to supplementary note 13, wherein
the storing unit stores the relational expression using a number of owned vehicles by vehicle type, the vehicles being the events, and the emission amount set according to the vehicle type, and also stores the second relational expression using the number of vehicles by the vehicle type and a cost of the vehicle, the cost being the evaluation value set according to the vehicle type.

### Supplementary Note 15

An information processing method comprising,
on a basis of a relational expression using a quantity of events by event type and an emission amount of a predetermined substance set according to the event type, calculating the quantity of the objects by the event type.

### Supplementary Note 16

The information processing method according to supplementary note 15, further comprising
calculating the quantity of the events by the event type on a basis of the relational expression so as to satisfy a condition set for a variable included in the relational expression.

### Supplementary Note 17

The information processing method according to supplementary note 15, further comprising
calculating the quantity of the events by the event type on a basis of a second relational expression and the relational expression, the second relational expression using the quantity of the events by the event type and an evaluation value that is set according to the event type and is different from the emission amount.

### Supplementary Note 18

The information processing method according to supplementary note 17, further comprising
calculating the quantity of the events by the event type on the basis of the relational expression and the second relational expression so as to satisfy a second condition set for a variable included in the second relational expression.

### Supplementary Note 19

A computer-readable storage medium storing thereon a program for causing a computer to execute processing to,
on a basis of a relational expression using a quantity of events by event type and an emission amount of a predetermined substance set according to the event type, calculate the quantity of the events by the event type.

### Supplementary Note 20

The computer-readable storage medium according to supplementary note 19, the medium storing thereon a program for causing the computer to execute processing to
calculate the quantity of the events by the event type on a basis of a second relational expression and the relational expression, the second relational expression using the quantity of the events by the event type and an evaluation value that is set according to the event type and is different from the emission amount.

### REFERENCE SIGNS LIST

10 information processing apparatus
11 acquiring unit
12 calculation unit
13 output unit
14 relational expression storing unit
100 information processing apparatus
101 CPU
102 ROM
103 RAM
104 programs
105 storage device
106 drive device
107 communication interface
108 input/output interface
109 bus
110 storage medium
111 communication network
121 storing unit
122 calculation unit

What is claimed is:

1. An information processing apparatus comprising:
at least one memory configured to store instructions; and
at least one processor configured to execute instructions to:
store a relational expression using a quantity of events by event type and an emission amount of a predetermined substance set according to the event type; and
calculate the quantity of the events by the event type on a basis of the relational expression

2. The information processing apparatus according to claim 1, wherein the at least one processor is configured to execute the instructions to
calculate the quantity of the events by the event type on a basis of the relational expression so as to satisfy a condition set for a variable included in the relational expression.

3. The information processing apparatus according to claim 2, wherein the at least one processor is configured to execute the instructions to
calculate the quantity of the events by the event type on the basis of the relational expression so as to satisfy the condition set for the emission amount included in the relational expression.

4. The information processing apparatus according to claim 2, wherein the at least one processor is configured to execute the instructions to
calculate the quantity of the events by the event type on the basis of the relational expression so as to satisfy the condition set for the quantity of the events by the event type included in the relational expression.

5. The information processing apparatus according to claim 1, wherein the at least one processor is configured to execute the instructions to:
store a second relational expression using the quantity of the events by the event type and an evaluation value that is set according to the event type and is different from the emission amount; and
calculate the quantity of the events by the event type based on the relational expression and the second relational expression.

6. The information processing apparatus according to claim 5, wherein the at least one processor is configured to execute the instructions to
calculate the quantity of the events by the event type on the basis of the relational expression and the second relational expression so as to satisfy a second condition set for a variable included in the second relational expression.

7. The information processing apparatus according to claim 6, wherein the at least one processor is configured to execute the instructions to
calculate the quantity of the events by the event type on the basis of the relational expression and the second relational expression so as to satisfy the second condition set for the evaluation value included in the second relational expression.

8. The information processing apparatus according to claim 6, wherein the at least one processor is configured to execute the instructions to
calculate the quantity of the events by the event type on the basis of the relational expression and the second relational expression so as to satisfy the second condition set for the quantity of the events by the event type included in the second relational expression.

9. The information processing apparatus according to claim 1, wherein the at least one processor is configured to execute the instructions to:
store the relational expression using the quantity of the events by the event type and the emission amount for each period set in advance; and
calculate the quantity of the events by the event type for the each period on a basis of the relational expression.

10. The information processing apparatus according to claim 5, wherein the at least one processor is configured to execute the instructions to:
store the relational expression using the quantity of the events by the event type and the emission amount for each period set in advance, and store the second relational expression using the quantity of the events by the event type and the evaluation value for the each period; and
calculate the quantity of the events by the event type for the each period on the basis of the relational expression and the second relational expression.

11. The information processing apparatus according to claim 1, wherein the at least one processor is configured to execute the instructions to
store the relational expression using the quantity of the events by the event type set according to an energy usage status by the event, and the emission amount set according to the event type.

12. The information processing apparatus according to claim 11, wherein the at least one processor is configured to execute the instructions to
store the relational expression using a number of owned vehicles by vehicle type, the vehicles being the events, and the emission amount set according to the vehicle type.

13. The information processing apparatus according to claim 5, wherein the at least one processor is configured to execute the instructions to
store the relational expression using the quantity of the events by the event type set according to an energy usage status by the event and the emission amount set according to the event type, and also store the second relational expression using the quantity of the events by the event type and the evaluation value set according to the event type.

14. The information processing apparatus according to claim 13, wherein the at least one processor is configured to execute the instructions to
the storing unit store the relational expression using a number of owned vehicles by vehicle type, the vehicles being the events, and the emission amount set according to the vehicle type, and also store the second relational expression using the number of vehicles by the vehicle type and a cost of the vehicle, the cost being the evaluation value set according to the vehicle type.

15. An information processing method comprising,
on a basis of a relational expression using a quantity of events by event type and an emission amount of a predetermined substance set according to the event type, calculating the quantity of the events by the event type.

16. The information processing method according to claim 15, further comprising
calculating the quantity of the events by the event type on a basis of the relational expression so as to satisfy a condition set for a variable included in the relational expression.

17. The information processing method according to claim 15, further comprising
calculating the quantity of the events by the event type on a basis of a second relational expression and the relational expression, the second relational expression using the quantity of the events by the event type and an evaluation value that is set according to the event type and is different from the emission amount.

18. The information processing method according to claim 17, further comprising
calculating the quantity of the events by the event type on the basis of the relational expression and the second relational expression so as to satisfy a second condition set for a variable included in the second relational expression.

19. A non-transitory computer-readable storage medium storing thereon a program comprising instructions for causing a computer to execute processing to,
on a basis of a relational expression using a quantity of events by event type and an emission amount of a predetermined substance set according to the event type, calculate the quantity of the events by the event type.

20. The non-transitory computer-readable storage medium according to claim 19, the medium storing thereon a program comprising instructions for causing the computer to execute processing to
calculate the quantity of the events by the event type on a basis of a second relational expression and the relational expression, the second relational expression using the quantity of the events by the event type and an evaluation value that is set according to the event type and is different from the emission amount.
